(19) United States
(12) Patent Application Publication
(10) Pub. No.: US 2011/0026635 A1
(43) Pub. Date: Feb. 3, 2011

(54) WIRELESS RECEIVER, WIRELESS TRANSMITTER, AND FEEDBACK METHOD

(75) Inventors: Ryohei Kimura, Tokyo (JP); Katsuhiko Hiramatsu, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/935,449

(22) PCT Filed: Apr. 8, 2009
(86) PCT No.: PCT/JP2009/001637

§ 371 Date: Sep. 29, 2010

(30) Foreign Application Priority Data
Apr. 9, 2008 (JP) 2008-101176

(51) Int. Cl. H04B 15/00; H04L 27/00

(52) U.S. Cl. 375/285; 375/316

(57) ABSTRACT

Provided are a wireless receiver, a wireless transmitter, and a feedback method, with which the amount of CQI feedback in a MIMO channel is reduced. A channel estimation section (103) estimates a channel matrix of each RB between each transmitting/receiving antenna and performs the eigenvalue-decomposition of the estimated channel matrices to obtain the eigenvalues and eigenvectors by using a received pilot signal. A feedback information generating section (104) averages the eigenvalues for each RB and converts the averaged eigenvalues into a CQI for each stream to obtain the average CQI of the entire transmission band of a k-th stream. Further, the feedback information generating section (104) calculates a relative value (Dk) between the average CQI of a first stream and the average CQI of the k-th stream and determines the number of quantization bits to be allocated to the CQI of each of the streams to generate CQI feedback information.

### 1. TECHNICAL FIELD

The present invention relates to a radio reception apparatus, radio transmission apparatus and feedback method.

### 2. BACKGROUND ART

MIMO (Multiple-Input Multiple-Output) is a technology in which a transmission apparatus and a reception apparatus are both equipped with a plurality of antennas and perform high-speed, large-volume information transmission. Specifically, a plurality of items of data can be transmitted at the same time using the same frequency, enabling a high transmission speed to be achieved.

In this MIMO transmission method, a transmission method called “eigenmode transmission” is known. In eigenmode transmission, information concerning a propagation channel between transmission and reception apparatuses is obtained by means of channel estimation, and correlation matrix H^{H}H of the obtained propagation channel information (propagation channel matrix H) undergoes eigenvalue decomposition to obtain eigenvalue matrix Λ and eigenvector W. This is illustrated in equation 1. Then parallel transmission equivalent to the number of eigenvalues is possible by using wh^{H} as a transmission weight and W^{H} as a reception weight. A conceptual diagram of eigenmode transmission is shown in FIG. 1.

$$\begin{matrix}( Equation 1 ) & \\ \begin{matrix}{H}^{H} H = W Λ {W}^{H} \\ = ( \begin{matrix}{w}_{1} & {w}_{2} & {w}_{3} & {w}_{4}\end{matrix} ) ( \begin{matrix}{λ}_{1} & 0 & 0 & 0 \\ 0 & {λ}_{2} & 0 & 0 \\ 0 & 0 & {λ}_{3} & 0 \\ 0 & 0 & 0 & {λ}_{4}\end{matrix} ) {( \begin{matrix}{w}_{1} & {w}_{2} & {w}_{3} & {w}_{4}\end{matrix} )}^{H}\end{matrix} \\ {W}^{H} {H}^{H} H W = diag ( {λ}_{1} , {λ}_{2} , {λ}_{3} , {λ}_{4} ) \\ Λ \text{:} Diagonal matrix , W \text{:} Unitary matrix & [ 1 ]\end{matrix}$$

Here, λₖ is the k-th eigenvalue, and the relationship λᵣ>λ₂>λ₃>λ₄ applies. Transmission weight wₖ is assigned to k-th stream sₖ, and transmission is performed using the channel of k-th eigenvalue λₖ. Consequently, when eigenvalue number (stream number) k is smaller, higher transmission quality can be achieved.

By the way, as a technology for improving the cell throughput in a 3GPP (3rd Generation Partnership Project) LTE (Long Term Evolution) downlink, there is frequency scheduling (multi-user scheduling). Each terminal feeds back to the base station a CQI (Channel Quality Indicator) that is determined based on an SINR (Signal to Interference and Noise Ratio) for each RB (Resource Block), and the base station allocates communication resources to terminals using these CQI's.

The base station allocates a communication resource preferentially to a terminal that feeds back a higher CQI. Consequently, since the number of terminals that feed back a high CQI increases as the number of terminals increases, there is an improvement in cell throughput (peak data rate and frequency utilization efficiency). CQI feedback methods include Best-M reporting and DCT (Discrete Cosine Transform) reporting.

FIG. 2 shows an overview of Best-M reporting. In Best-M reporting, an average CQI (represented by X bits) of an entire transmission band (N_{RB}) and the top M RB's with a high CQI level are selected, and CQI's corresponding to the selected RB's (the CQI of each RB being represented by Y bits) and the positions of the selected RB's (represented by log₂(_{NRB}C_{M}) bits) are fed back. By this means, a total of X+YM+log₂(_{NRB}C_{M}) bits are fed back. A difference value between the top M CQI's and the average CQI is represented by number of quantization bits Y.

FIG. 3 shows the CQI feedback format in Best-M reporting. Here, a case is shown in which X=5 bits, Y=3 bits, and M=5. The base station demodulates the Best-M reporting feedback information, and reproduces the CQI of each RB.

FIG. 4 shows an overview of DCT reporting. In DCT reporting, the direct current (DC) component (represented by X bits) and lower M frequency components (represented by Y bits per frequency) other than the DC component are fed back from a result of performing DCT transform of the SINR of each RB. By this means, a total of X+MY bits are fed back. In DCT reporting, M frequency components are fed back in order from the lowest frequency, and therefore position information about RB's needs not be fed back unlike Best-M reporting.

FIG. 5 shows the CQI feedback format in DCT reporting. Here, a case is shown in which X=5 bits, Y=5 bits, and M=4. The base station performs IDCT (Inverse Discrete Cosine Transform) transform of the DCT reporting feedback information, and reproduces the SINR of each RB.

When CQI's are fed back in the above MIMO communication, SINRₖ of the k-th stream is used as a quality indicator, and CQI conversion of an SINR is performed for each stream in the case of Best-M reporting, while DCT transform of an SINR is performed for each stream in the case of DCT reporting. Also, when CQI's are fed back in the above eigenmode transmission, eigenvalue λₖ is used as a quality indicator instead of SINRₖ, and CQI conversion of eigenvalue λₖ is performed in the case of Best-M reporting, while DCT transform of eigenvalue λₖ is performed in the case of DCT reporting.

### CITATION LIST

### Non-Patent Literature

NPL 1: 3GPP, R1-062954, LG Electronics, “Analysis on DCT based CQI reporting Scheme”, RAN1#46-bis, Seoul, Oct. 9-13, 2006

### SUMMARY OF INVENTION

### Technical Problem

In eigenmode transmission, an eigenvalue is used as a quality indicator. The frequency fluctuation of this eigenvalue varies between streams, and, consequently, the CQI's of streams are quantized by different numbers of quantization bits to optimize the number of CQI quantization bits in each CQI. That is, the CQI format varies between streams. In this case, as shown in FIG. 6, there is a problem that an indicator for reporting the CQI format of each stream (i.e. CQI format indicator) is necessary and therefore the amount of CQI feedback increases.

It is therefore an object of the present invention to provide a radio reception apparatus, radio transmission apparatus and feedback method that reduce the amount of CQI feedback in a MIMO channel.

### Solution to Problem

The radio reception apparatus of the present invention employs a configuration having: a reception section that receives signals transmitted from a plurality of antennas, via a plurality of antennas; a channel estimating section that estimates channel matrixes between transmission antennas and reception antennas, using pilot signals in the received signals, and obtains eigenvalues by eigenvalue decomposition of the estimated channel matrixes; a feedback information generating section that obtains a difference of quality indicators between streams, the quality indicators corresponding to average eigenvalues of the streams, determines a number of quantization bits corresponding to the difference and generates feedback information by quantizing M quality indicators representing a degree of fluctuation of the eigenvalues with the determined number of quantization bits; and a transmission section that transmits the feedback information.

The radio transmission apparatus of the present invention employs a configuration having: a reception section that receives feedback information including quality indicators corresponding to average eigenvalues of streams; and a feedback information demodulating section that obtains a difference of the quality indicators between the streams, and demodulates the feedback information based on a number of quantization bits corresponding to the difference.

The feedback method of the present invention includes: estimating channel matrixes between a plurality of transmission antennas and a plurality of reception antennas, and obtaining eigenvalues by eigenvalue decomposition of the estimated channel matrixes; estimating a channel matrix between a transmission antenna and a reception antenna using a pilot signal in a received signal, and obtaining eigenvalues by eigenvalue decomposition of the estimated channel matrix; obtaining a difference of quality indicators between streams, the quality indicators corresponding to average eigenvalues of streams; determining a number of quantization bits corresponding to the difference; generating feedback information by quantizing M quality indicators representing a degree of fluctuation of the eigenvalues with the determined number of quantization bits; and transmitting the feedback information.

### ADVANTAGEOUS EFFECTS OF INVENTION

The present invention enables the amount of CQI feedback in a MIMO channel to be reduced.

### BRIEF DESCRIPTION OF DRAWINGS

FIG. 1 is a conceptual diagram showing eigenmode transmission;

FIG. 2 shows an overview of Best-M reporting;

FIG. 3 shows a CQI feedback format according to Best-M reporting;

FIG. 4 shows an overview of DCT reporting;

FIG. 5 shows a CQI feedback format according to DCT reporting;

FIG. 6 shows a state where a CQI format indicator is required per stream;

FIG. 7 is a block diagram showing the configuration of a reception apparatus according to Embodiment 1 of the present invention;

FIG. 8 shows how CQI conversion is performed on the eigenvalues of first to fourth streams;

FIG. 9 shows a CQI feedback table according to Embodiment I of the present invention;

FIG. 10 shows eigenvalue fluctuation in the frequency domain;

FIG. 11 shows a CQI feedback format according to Embodiment 1 of the present invention;

FIG. 12 is a block diagram showing the configuration of a transmission apparatus according to Embodiment I of the present invention;

FIG. 13 shows how DCT transform is performed on the eigenvalues of first to fourth streams;

FIG. 14 shows a CQI feedback table according to Embodiment 2 of the present invention; and

FIG. 15 shows a CQI feedback format according to Embodiment 2 of the present invention.

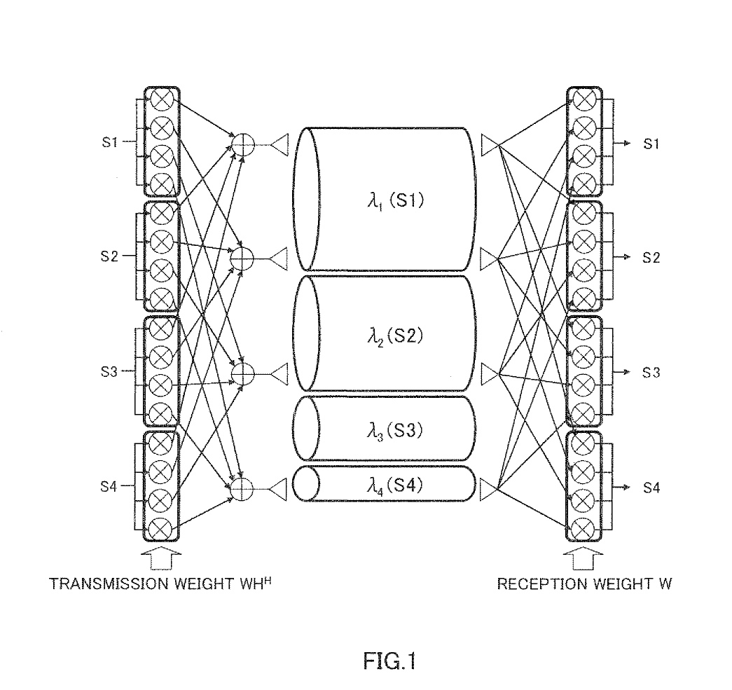

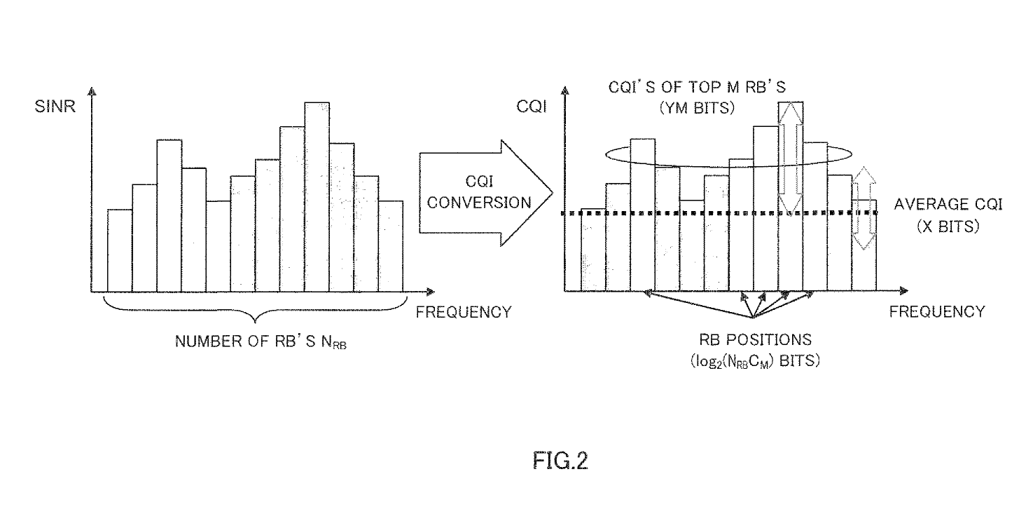

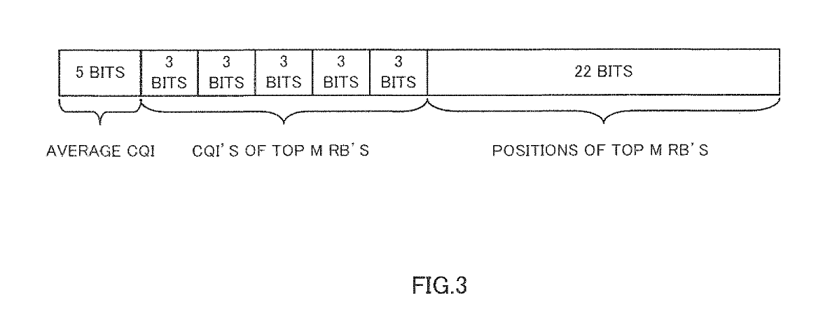

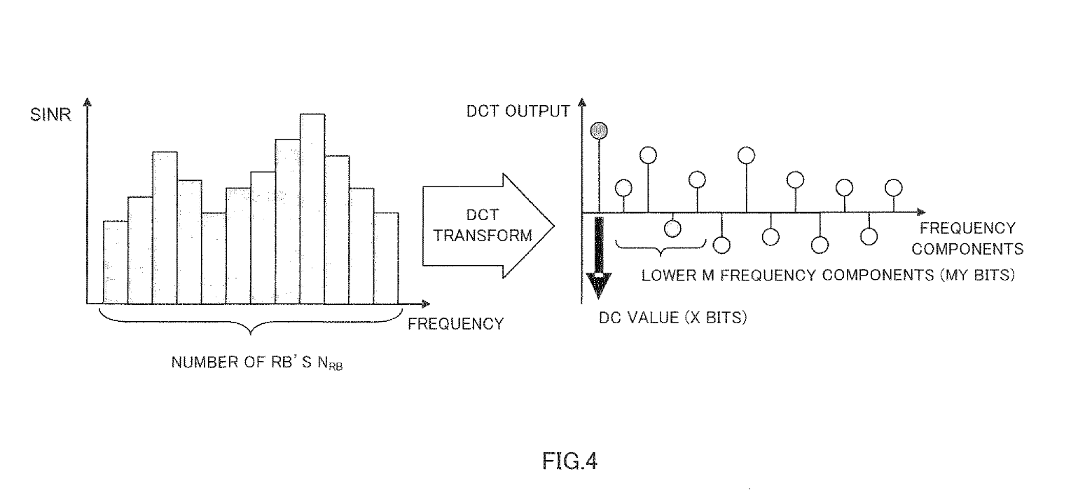

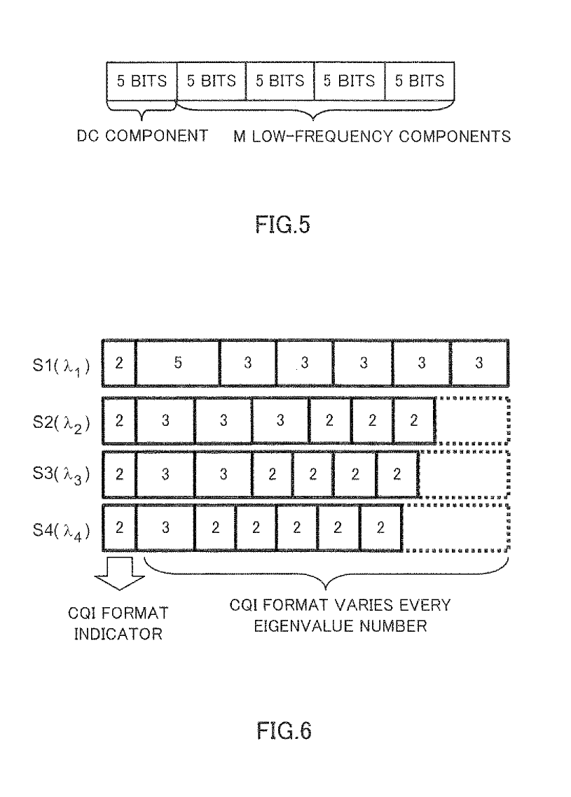

### DESCRIPTION OF EMBODIMENTS

Now, embodiments of the present invention will be described in detail with reference to the accompanying drawings.

### Embodiment 1

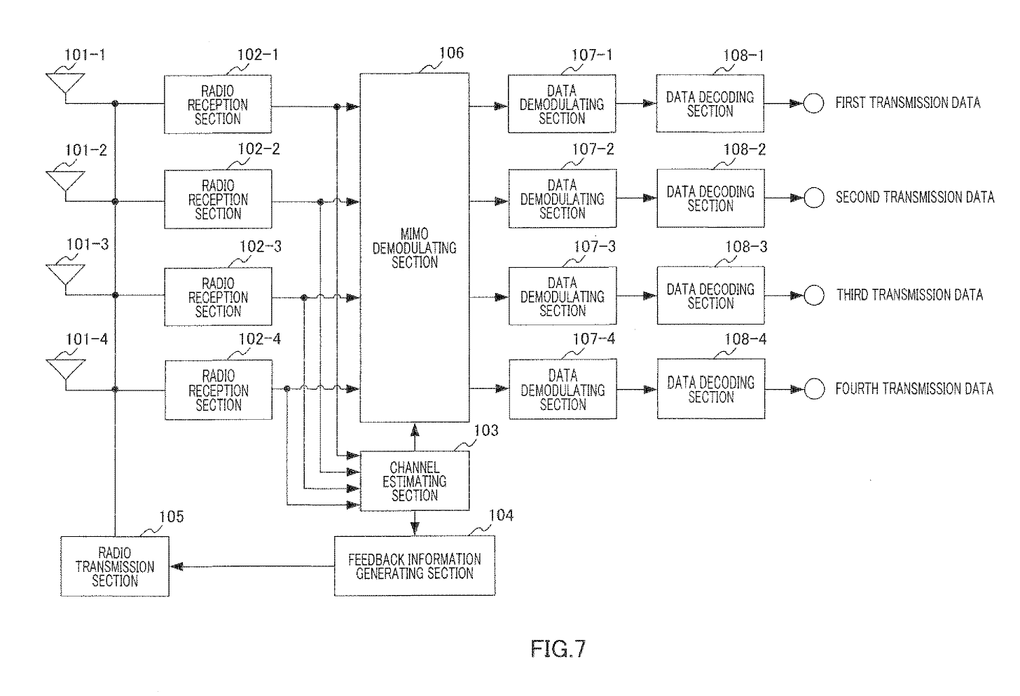

FIG. 7 is a block diagram showing the configuration of a reception apparatus according to Embodiment 1 of the present invention. Here, a case will be explained where four antennas are provided. Radio reception sections 102-1 to 102-A down-convert signals received via corresponding antennas 101-1 to 101-4 to baseband signals, output data signals in the received signals to MIMO demodulating section 106, and output pilot signals in the received signals to channel estimating section 103.

Channel estimating section 103 uses the pilot signals outputted from radio reception sections 102-1 to 102-4 to estimate a channel matrix for each RB between transmission and reception antennas, and performs eigenvalue decomposition of the estimated channel matrixes to obtain eigenvalues and eigenvectors. The obtained eigenvectors are outputted to feedback information generating section 104 as transmission weights, and values obtained by multiplying the eigenvectors by the channel matrixes are outputted to MIMO demodulating section 106 as reception weights. A channel matrix is a matrix representing channel gain between a transmission antenna and a reception antenna.

Feedback information generating section 104 averages eigenvalues outputted from channel estimating section 103 for each RB, and converts the average eigenvalue to a CQI for each eigenvalue number (stream). Feedback information generating section 104 generates CQI feedback information by the numbers of quantization bits determined for each eigenvalue number, and outputs this information to radio transmission section 105. Feedback information generating section 104 will be described later in detail.

Radio transmission section 105 up-converts the feedback information outputted from feedback information generating section 104, and transmits the result from antennas 101-1 to 101-4.

MIMO demodulating section 106 multiplies the data signals outputted from radio reception sections 102-1 to 102-4 by the reception weights outputted from channel estimating section 103, and demultiplexes streams. The demultiplexed streams are outputted to data demodulating sections 107-1 to 107-4 respectively.

Data demodulating sections 107-1 to 107-4 convert the streams outputted from MIMO demodulating section 106, from modulation symbols to soft decision bits, and output the results to data decoding sections 108-1 to 108-4. Data decoding sections 108-1 to 108-4 perform channel decoding of the soft decision bits outputted from data demodulating sections 107-1 to 107-4, and restore transmission data.

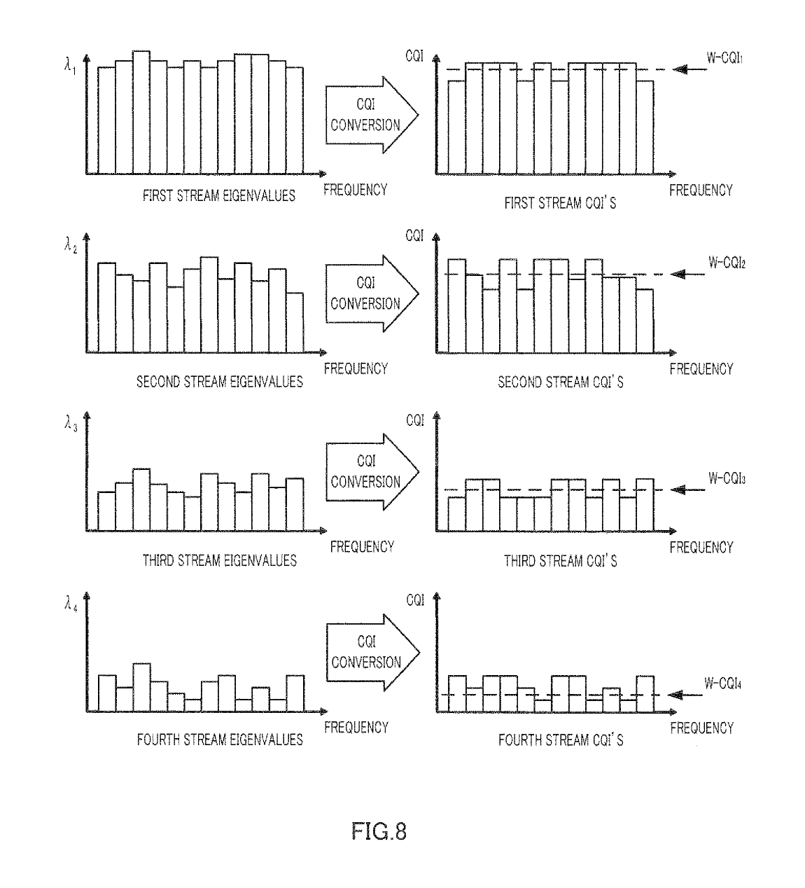

Next, feedback information generation in feedback information generating section 104 described above will be explained in detail. As shown in FIG. 8, feedback information generating section 104 converts the average eigenvalue per RB to the CQI's for each eigenvalue number (stream), and calculates the average CQI of the entire transmission band in the k-th stream. Also, feedback information generating section 104 selects the top M RB's with a high CQI in each stream.

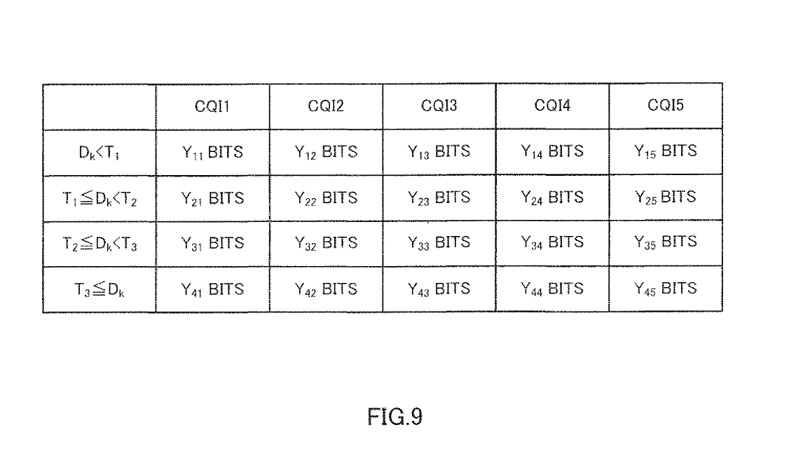

On the other hand, feedback information generating section 104 calculates relative value Dₖ, which is the difference between average CQI (W−CQI₁) of the first stream and average CQI (W−CQIₖ) of the k-th (where k is equal to or greater than 2) stream, and uses calculated relative value Dₖ as a quantization bit selection indicator. That is, the numbers of quantization bits assigned to the stream CQI's are determined by relative value Dₖ. For example, assume that feedback information generating section 104 has the feedback table shown in FIG. 9. In this figure, the relationship of T₁<T₂<T₃ holds, CQI's 1 to 5 represent the top CQI's in the case of M=5, and Y₁₁ to Y₄₅ represent the numbers of CQI quantization bits. Also, number of quantization bits Yᵢⱼ for CQIj (1≦j≦5) holds the relationship of Y₁ⱼ≧Y₂ⱼ≧Y₃ⱼ≧Y₄ⱼ. This is because, when relative value Dₖ is large, the eigenvalues after the second stream are small, and therefore it is possible to maintain the accuracy of quantization bits if the number of quantization bits is decreased.

Here, if relative value Dₖ is equal to or above T₁ but below T₂, the numbers of quantization bits for the top M CQI's in the k-th stream are from Y₂₁ to Y₂₅ bits. Also, regardless of the relative value, the average CQI of each stream and CQI's 1 to 5 in the first stream are quantized by a certain number of quantization bits.

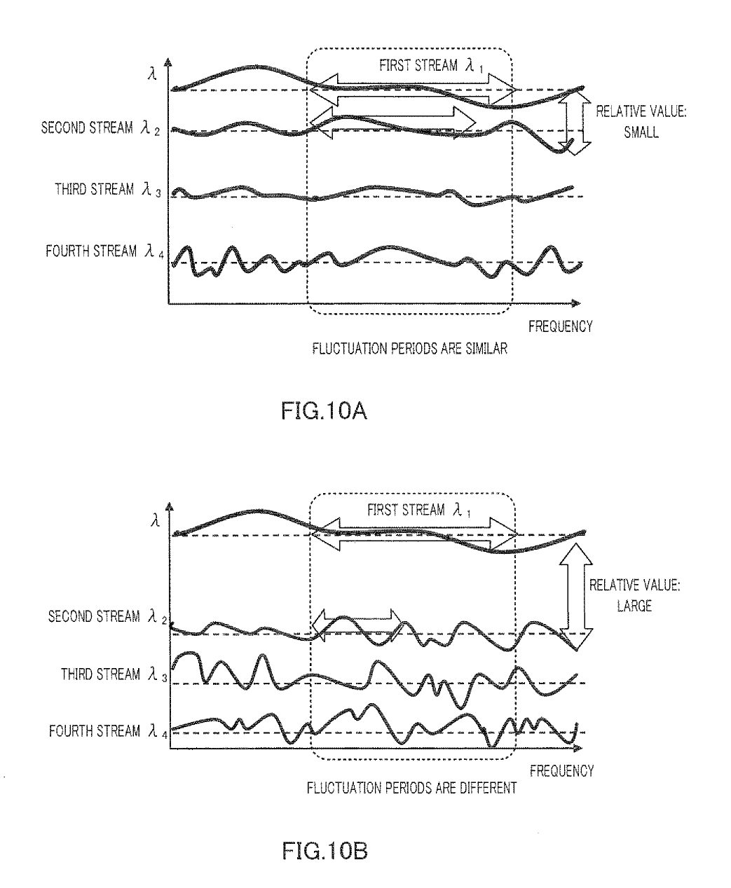

The feedback table shown in FIG. 9 is determined by the following features of eigenvalues in the frequency domain. That is, as shown in FIG. 10A, when the channel correlation is low, the difference between average eigenvalues is small, and therefore the frequency fluctuation is similar between streams. By contrast, as shown in FIG. 10B, when the channel correlation is high, differences between the eigenvalues of the first stream and the eigenvalues of a second stream or later become large. Here, the frequency fluctuation of the eigenvalues of the first stream is insignificant and the frequency fluctuation of the eigenvalues of the second stream or later is significant.

In view of the above, the relationship between the average eigenvalue of the first stream and the average eigenvalue of the second stream or later varies between a ease where the channel correlation is low and a case where the channel correlation is high. Consequently, in these cases, the number of optimal quantization bits to represent the eigenvalues of the second stream or later varies.

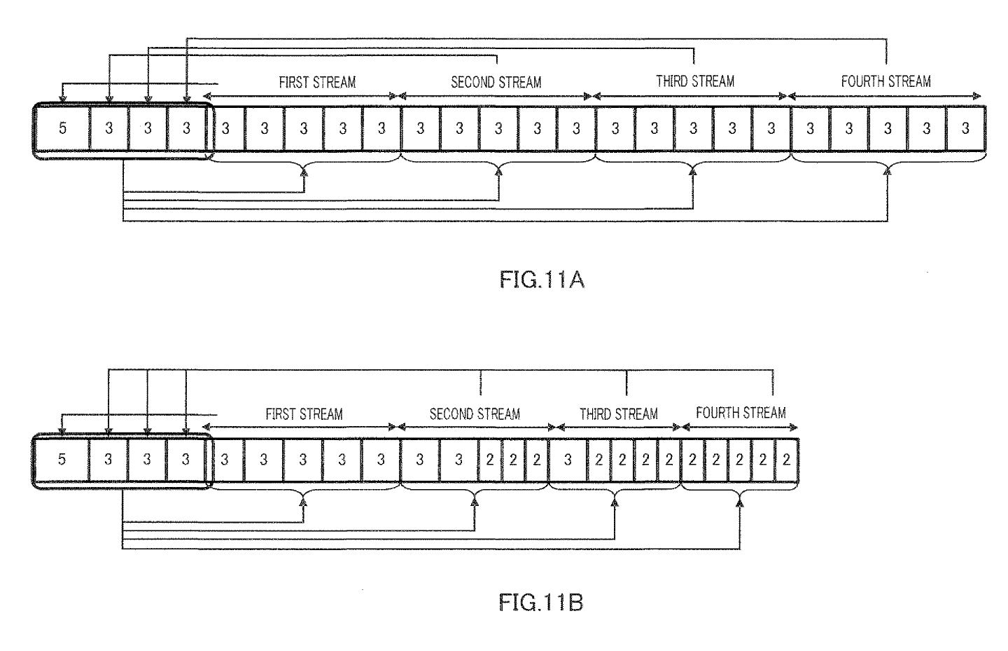

Thus, relative value Dₖ is calculated, and CQI feedback information is generated based on the number of CQI quantization bits corresponding to calculated relative value Dₖ. FIG. 11 shows CQI feedback formats. FIG. 11A shows a CQI feedback format in the case where relative value Dₖ is small, and FIG. 11B shows a CQI feedback format in the case where relative value Dₖ is large. According to the present embodiment, a CQI feedback format is determined from relative value Dₖ of average CQI's, so that a CQI format indicator is not necessary. Also, the number of quantization bits for average CQI's is fixed regardless of stream numbers, and the number of quantization bits for CQI's other than the average CQI's is variable in the second stream or later.

Therefore, in order to determine the numbers of quantization bits for CQI's (i.e. CQI's 1 to 5) other than average CQI's based on relative value Dₖ in the transmission apparatus, it is necessary to share the allocation positions of quantization bits for the average CQI's between the transmission apparatus and the reception apparatus. With the present embodiment, quantization bits for the average CQI of each stream are collectively allocated to the head of the CQI feedback format. That is, the average CQI's in which the number of quantization bits does not change are allocated to the head, and CQI's 1 to 5 of the second stream or later, in which the number of quantization bits is variable, are allocated after the average CQI's.

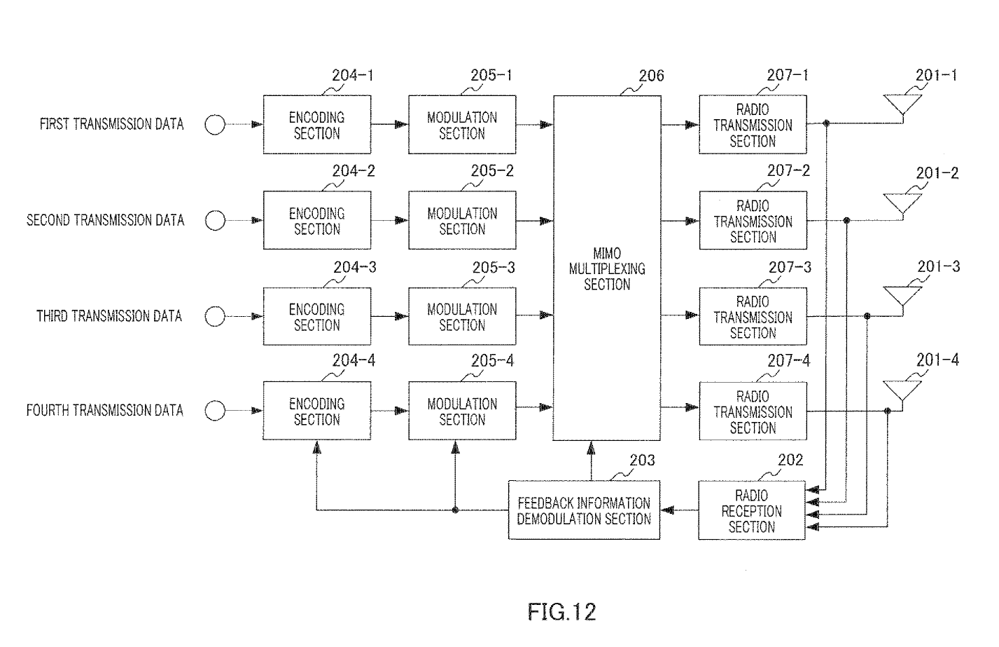

FIG. 12 is a block diagram showing the configuration of a transmission apparatus according to Embodiment 1 of the present invention. Here, a case will be explained where four antennas are provided. Radio reception section 202 receives feedback information fed back from the reception apparatus, via antennas 201-1 to 201-4, down-converts the received feedback information to baseband signals and outputs these to feedback information demodulating section 203.

Feedback information demodulating section 203 has the same CQI feedback table as the CQI feedback table provided in feedback information generating section 104 of the reception apparatus shown in FIG. 9, demodulates the feedback information outputted from radio reception section 202 based on the CQI feedback table, and obtains transmission weights and CQI's (channel coding rates and modulation levels). The obtained transmission weights are outputted to MIMO multiplexing section 206, the channel coding rates are outputted to encoding sections 204-1 to 204-4, and the modulation levels are outputted to modulating sections 205-1 to 205-4. Feedback information demodulating section 203 will be described later in detail.

Encoding sections 204-1 to 204-4 encode each input transmission data by the channel coding rates outputted from feedback information demodulating section 203, and output the resulting encoded data to modulating sections 205-1 to 205-4. Modulating sections 205-1 to 205-4 modulate the encoded data outputted from encoding sections 204-1 to 204-4 by the modulation levels outputted from feedback information demodulating section 203, and output modulation symbols to MIMO multiplexing section 206.

MIMO multiplexing section 206 converts the modulation symbols outputted from modulating sections 205-1 to 205-4 to transmission streams by multiplying the modulation symbols by the transmission weights outputted from feedback information demodulating section 203. MIMO multiplexing section 206 multiplexes all of the transmission streams and outputs the results to radio transmission sections 207-1 to 207-4.

Radio transmission sections 207-1 to 207-4 up-convert the transmission streams outputted from MIMO multiplexing section 206, and transmit the results from antennas 201-1 to 201-4.

Next, feedback information demodulation by feedback information demodulating section 203 described above will be explained in detail. Feedback information demodulating section 203 demodulates the average CQI of each stream allocated to the head of a CQI feedback format. These average CQI's are determined in advance to have a predetermined number of quantization bits. Feedback information demodulating section 203 calculates relative value Dₖ using the demodulated average CQI's. To be more specific, similar to processing in the reception apparatus, feedback information demodulating section 203 calculates the difference (i.e. relative value Dₖ) between average CQI (W-CQI₁) of the first stream and average CQI (W-CQIₖ) of the k-th stream. Feedback information demodulating section 203 calculates the numbers of CQI quantization bits in each stream for calculated relative value Dₖ, from the CQI feedback table shown in FIG. 9, and demodulates CQI's based on the numbers of CQI quantization bits calculated.

Thus, according to Embodiment 1, in the case where CQI feedback is implemented based on Best-M reporting, by associating the relative value of average CQI's of streams with the numbers of quantization bits for the top M CQI's, and by generating CQI feedback information including the average CQI of each stream and the top M CQI's, it is possible to reduce the number of bits to use for a CQI format indicator and reduce the amount of CQI feedback.

### Embodiment 2

A case has been described with Embodiment 1 where CQI feedback is implemented based on the Best-M reporting, a case will be explained with Embodiment 2 where CQI feedback is implemented based on the DCT reporting. Here, the configurations of the reception apparatus and transmission apparatus according to Embodiment 2 of the present invention are similar to the configurations shown in FIG. 7 and FIG. 12 of Embodiment 1, except for part of the functions. Therefore, the different functions will be explained using FIG. 7 and FIG. 12.

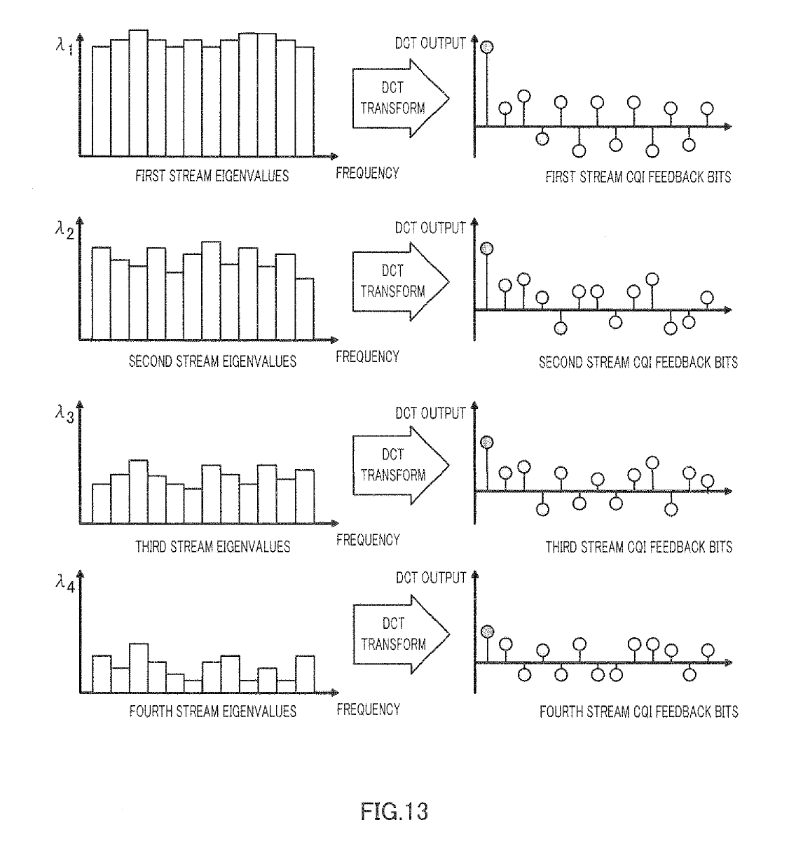

Feedback information generating section 104 according to Embodiment 2 of the present invention averages eigenvalues outputted from channel estimating section 103 for each RB and, as shown ion FIG. 13, converts the average eigenvalue to CQI's for each eigenvalue number (stream). Feedback information generating section 104 selects the DC component of the DCT output and lower M frequency components other than the DC component, as frequency components to feed back, generates CQI feedback information by the numbers of quantization bits determined for each eigenvalue number and outputs the feedback information to radio transmission section 105.

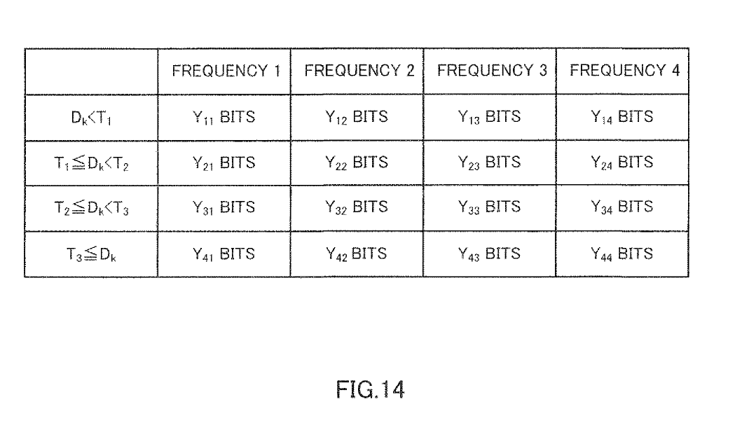

To be more specific, feedback information generating section 104 calculates relative value Dₖ representing the difference between the DC component (DC₁) in the first stream and the DC component (DCₖ) in the k-th stream (where k is equal to or greater than 2), and uses calculated relative value Dₖ as a selection measure of quantization bits. That is, the number of quantization bits assigned to the frequency components of each stream is determined according to relative value Dₖ. For example, assume that feedback information generating section 104 provides a feedback table as shown in FIG. 14. In this figure, the relationship of T₁<T₂<T₃ holds, frequencies 1 to 4 represent lower frequency components in the case of M=4, and Y₁₁ to Y₄₄ represent the number of quantization bits for each frequency component. Also, number of quantization bits Yᵢⱼ for frequency component j (1≦j≦4) holds the relationship of Y₁ⱼ≧Y₂ⱼ≧Y₃ⱼ≧Y₄ⱼ. Here, if relative value Dₖ is equal to or above T₁ but below T₂, the numbers of quantization bits for lower M frequency components in the k-th stream are from Y₂₁ to Y₂₄ bits. Also, regardless of the relative value, the DC component of each stream and frequencies 1 to 4 in the first stream are quantized by certain numbers of quantization bits.

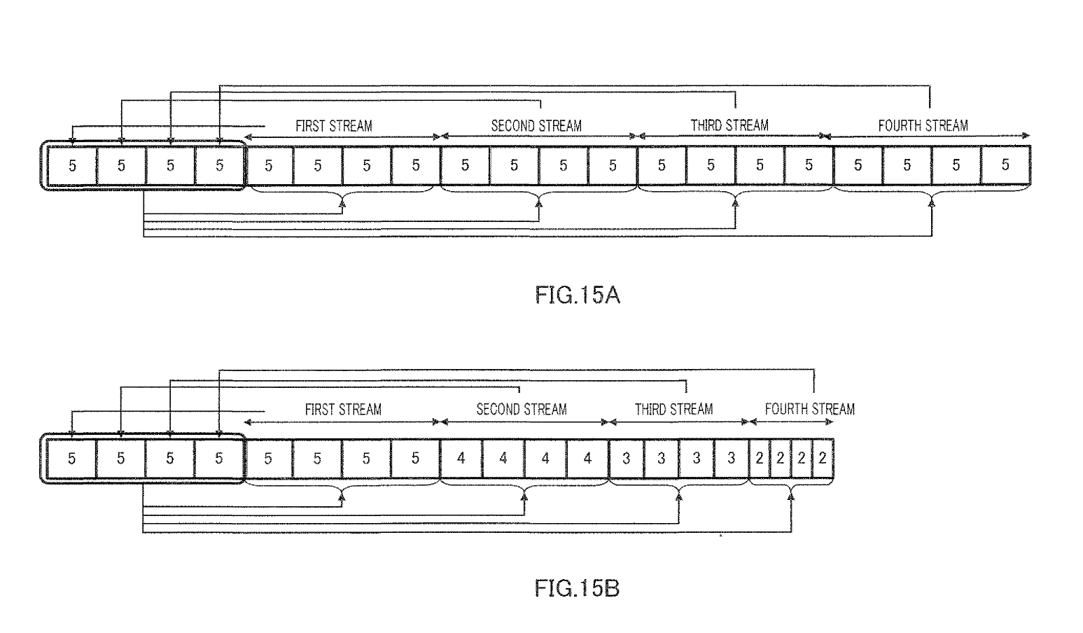

Thus, relative value Dₖ is calculated, and, based on the number of frequency quantization bits for calculated relative value Dₖ, CQI feedback information is generated. FIG. 15 shows a CQI feedback format. FIG. 15A shows a CQI feedback format in a case where relative value Dₖ is small, and FIG. 15B shows a CQI feedback format in a case where relative value Dₖ is large. With the present embodiment, a CQI feedback format is determined from relative value Dₖ of DC components, so that a CQI format indicator is not necessary. Also, the number of quantization bits for DC components is fixed regardless of stream numbers, and, in a second stream or later, the number of quantization bits for lower frequency components other than the DC component is variable.

Therefore, in order to determine the number of quantization bits for frequency components other than DC components based on relative value Dₖ in the transmission apparatus, it is necessary to share the allocation positions of quantization bits for the DC components between the transmission apparatus and the reception apparatuses. With the present embodiment, quantization bits for the DC component of each stream are collectively allocated to the head of a CQI feedback format. That is, the DC components in which the number of quantization bits does not change are allocated to the head, and frequencies 1 to 4 of the second stream or later, in which the number of quantization bits is variable, are allocated after the DC components.

Feedback information demodulating section 203 according to Embodiment 2 of the present invention has the same CQI feedback table as the CQI feedback table provided in feedback information generating section 104 of the reception apparatus shown in FIG. 14, demodulates feedback information outputted from radio reception section 202 based on the CQI feedback table, and obtains transmission weights and eigenvalues (channel coding rates and modulation levels). The obtained transmission weights are outputted to MIMO multiplexing section 206, the channel coding rates are outputted to encoding sections 204-1 to 204-4, and the modulation levels are outputted to modulating sections 205-1 to 205-4.

To be more specific, feedback information demodulating section 203 demodulates the DC component (Dₖ) of each stream allocated to the head of a CQI feedback format. These DC components are determined in advance to have a predetermined number of quantization bits. Feedback information demodulating section 203 calculates relative value Dₖ using the demodulated DC components. That is, similar to processing in the reception apparatus, feedback information demodulating section 203 calculates the difference (i.e. relative value Dₖ) between the DC component of the first stream (DC₁) and the DC component of the k-th stream (DCₖ). Feedback information demodulating section 203 calculates the numbers of quantization bits for the frequency components in each stream for calculated relative value Dₖ, from the CQI feedback table shown in FIG. 14, and calculates the eigenvalue per RB by applying IDCT transform to the DC component and M frequency components based on the numbers of quantization bits for frequency components calculated. The channel coding rates and the modulation levels are determined from the calculated eigenvalues, the channel coding rates are outputted to encoding sections 204-1 to 204-4, and the modulation levels are outputted to modulating sections 205-1 to 205-4.

Thus, according to Embodiment 2, in the case where CQI feedback is implemented based on DCT reporting, by associating the relative value of DC components of streams with the numbers of quantization bits for lower M frequency components, and by generating CQI feedback information including the DC component of each stream and the lower M frequency components, it is possible to reduce the number of bits to use for a CQI format indicator and reduce the amount of CQI feedback.

Although example cases have been described with the above embodiments where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-101176, filed on Apr. 9, 2008, including the specification, drawings and abstract, is incorporated herein by reference in its entirety.

### INDUSTRIAL APPLICABILITY

The radio reception apparatus, ratio transmission apparatus and feedback method according to the present invention can reduce the amount of CQI feedback, and are applicable to a mobile communication system, for example.

1. A radio reception apparatus comprising:
a reception section that receives signals transmitted from a plurality of antennas, via a plurality of antennas;
a channel estimating section that estimates channel matrixes between transmission antennas and reception antennas, using pilot signals in the received signals, and obtains eigenvalues by eigenvalue decomposition of the estimated channel matrixes;
a feedback information generating section that obtains a difference of quality indicators between streams based on the eigenvalue, the quality indicators corresponding to average eigenvalues of the streams, determines a number of quantization bits corresponding to the difference and generates feedback information by quantizing M quality indicators representing a degree of fluctuation of the eigenvalues with the determined number of quantization bits; and
a transmission section that transmits the feedback information.

2. The radio reception apparatus according to claim 1, wherein the feedback information generating section reduces the number of quantization bits to quantize the M quality indicators of a second stream or later, when the difference increases.

3. The radio reception apparatus according to claim 1, wherein the feedback information generating section collectively allocates the quality indicators corresponding to the average eigenvalues of the streams, to a head of a format of the feedback information.

4. A radio transmission apparatus comprising:
a reception section that receives feedback information including quality indicators corresponding to average eigenvalues of streams; and
a feedback information demodulating section that obtains a difference of the quality indicators between the streams, and demodulates the feedback information based on a number of quantization bits corresponding to the difference.

5. A feedback method comprising:
estimating channel matrixes between a plurality of transmission antennas and a plurality of reception antennas, and obtaining eigenvalues by eigenvalue decomposition of the estimated channel matrixes;
estimating a channel matrix between a transmission antenna and a reception antenna using a pilot signal in a received signal, and obtaining eigenvalues by eigenvalue decomposition of the estimated channel matrix;
obtaining a difference of quality indicators between streams based on the eigenvalue, the quality indicators corresponding to average eigenvalues of streams;
determining a number of quantization bits corresponding to the difference;
generating feedback information by quantizing M quality indicators representing a degree of fluctuation of the eigenvalues with the determined number of quantization bits; and
transmitting the feedback information.
